(19) United States
(12) Patent Application Publication
(10) Pub. No.: US 2003/0117400 A1
(43) Pub. Date: Jun. 26, 2003

(54) Color display instrument and method for use thereof

(76) Inventors: Goodwin Steinberg, Palo Alto, CA (US); Robert A. Grimm, Los Altos, CA (US)

Correspondence Address: DORSEY & WHITNEY LLP, INTELLECTUAL PROPERTY DEPARTMENT, 4 EMBARCADERO CENTER, SUITE 3400, SAN FRANCISCO, CA, 94111, US

(21) Appl. No.: 10/247,605

(22) Filed: Sep. 18, 2002

Related U.S. Application Data
(63) Continuation-in-part of application No. 10/028,809, filed on Dec. 21, 2001.

(51) Int. Cl. G06T 11/20

(52) U.S. Cl. 345/440

(57) ABSTRACT

A method for graphically displaying on a display device, a musical note in a range of notes within an octave, in a range of octaves. The method including, determining the display attributes of a reference octave selected from the range of octaves, receiving a musical note, generating a representation of the received musical note using a note position of the received note in an octave and a relative octave position to the reference octave, and sending the representation for graphical display. A system is also disclosed.

### CROSS-REFERENCES TO RELATED APPLICATIONS

This application is a Continuation-in-Part of U.S. patent application Ser. No. 10/028,809 filed Dec. 21, 2001, entitled ELECTRONIC COLOR DISPLAY INSTRUMENT AND METHOD, naming Goodwin Steinberg and Robert A. Grimm as inventors, with Attorney Docket No. A-69885/AJT. U.S. patent application Ser. No. 10/028,809 is incorporated by reference herein.

### BACKGROUND OF THE INVENTION

1. Field of the Invention

This invention relates, in general, to musical instruments and more particularly a color display instrument for generating visual displays of notes and methods for their use.

2. Description of Related Art

Musical instruments are well known for producing sound. A number of modern musical instruments may be attached to musical devices for enhancing sound. Typically, the attachment include a MIDI (Musical Instrument Digital Interface) interface, which is a common standard for representing musical information in a digital format. For example, a piano keyboard may have a MIDI interface that can be attached to an amplifier. When a key is pressed on a piano keyboard, a MIDI signal is transmitted from the piano keyboard to the amplifier. The amplifier can interpret the transmitted signal to determine which note was pressed on the piano keyboard including a variety of attributes associated with the piano key pressed. Unfortunately, musical instruments generate sound and not graphical representations. Consequently, a beautiful melody can only be and never seen.

What is needed is a color display instrument which overcomes the above and disadvantages of musical instruments and musical information stored in a digital

### BRIEF SUMMARY OF THE INVENTION

In summary, one aspect of the present invention is directed to a method for graphically displaying on a display device, a musical note in a range of notes within an octave, in a range of octaves. The method includes, determining the display attributes of a reference octave selected from the range of octaves, receiving a musical note, generating a representation of the received musical note using a note position of the received note in an octave and a relative octave position to the reference octave, and sending the representation for graphical display.

### BRIEF DESCRIPTION OF THE DRAWINGS

FIG. 1 is a block diagram of a color display instrument employing a personal computer and piano keyboard, in accordance with the present invention.

FIG. 2 is a block diagram of another embodiment of color display instrument, in accordance with the present invention.

FIG. 3 is a block diagram of a system including a color display instrument, in accordance with the present invention.

FIG. 4 is a block diagram of a note in a note group, in accordance with the present invention.

FIG. 5 is a flowchart illustrating the operation of the color display instrument, according to the present invention.

FIG. 6 is a flowchart illustrating the determination of reference display attributes, according to the present invention.

FIG. 7 is a flowchart illustrating the generate representation, according to the present invention.

FIG. 8 is a flowchart illustrating the determine note attributes, according to the present invention.

FIG. 9 is a flowchart illustrating the define color palette, according to the present invention.

FIG. 10 is a flowchart illustrating the definition of a color palette, according to the present invention.

FIG. 11 is an example artwork for use according to the present invention.

FIG. 12 is an example color wheel and a reference octave, according to the present invention.

FIG. 13 is an illustrative mapping of a color associated with one note of a reference octave with similar notes in the range of octaves, according to the present invention.

FIG. 14 illustrates example patterns for graphically representing a note, according to the present invention.

FIG. 15 is a series of example patterns that may be formed in succession to illustrate and exploding effect, according to the present invention.

FIG. 16 is a perspective view of a display including a contiguous display path, according to the present invention.

FIG. 17 is a perspective view of a display including a spiral display path, according to the present invention.

FIG. 18 is a perspective view of a display including a wave display path, according to the present invention.

FIG. 19 is a perspective view of the display including a mock piano keyboard, according to the present invention.

FIG. 20 is a perspective view of the display including four mock piano keyboards, according to the present invention.

FIG. 21 is a perspective view of the display including four mock piano keyboards and corresponding display paths, according to the present invention.

FIG. 22 represents FIG. 21 including notes being played in on the respective four keyboards.

FIG. 23 depicts an embodiment of a method implemented on a computer readable media, according to the present invention.

FIG. 24 depicts an embodiment of a method executed by a computer system, according to the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to those embodiments. On the contrary, the invention is intended to cover alternatives, modifications and equivalents, which may be included within the spirit and scope of the invention as defined by the appended claims.

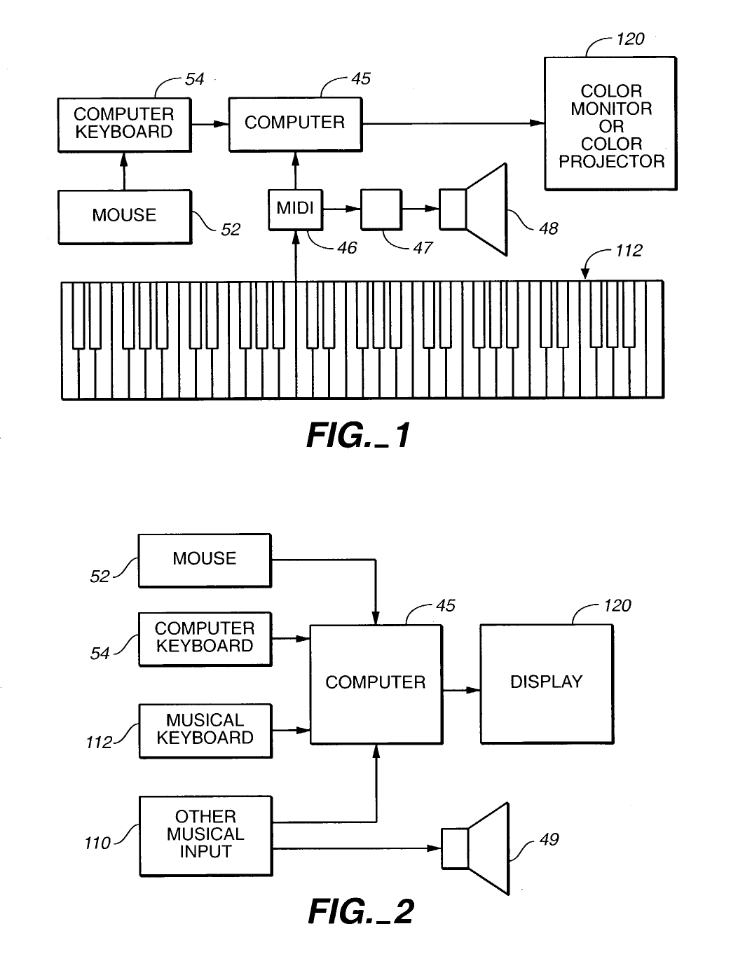

Turning now to the drawings, wherein like components are designated by like reference numerals throughout the various figures, attention is directed to FIG. 1 illustrating a color display instrument. The color display instrument may include a personal computer 45 which is programmed to receive notes from a piano-like keyboard 112. Depression of a key on the piano-like keyboard gives an output digital note indicative of the key. The digital note may include information representing the key and further including information regarding duration, intensity, velocity, etc. of the keys depression. One such digital coding system 46 can, for example, be the coding system known as MIDI. A keyboard capable of playing music may also include a sound circuit 47 for processing the digital signals and driving one or more speakers 48.

It should also be apparent that a variety of musical formats, graphical formats, methods, processing approaches, and/or combinations may be used in accordance with the present invention. According to one embodiment, the personal computer 45 may be programmed to receive digital notes, analog notes, and/or a combination, such as for example, digital notes from the piano-like keyboard 112 and analog notes from a singer's microphone. According to one embodiment, the computer 45 may receive analog inputs and may generate analog outputs. Further, a digital and/or analog computer keyboard 54 may be coupled with the computer 45. A variety of implementations may be used in support of the present invention.

In accordance with one embodiment of the present invention, the computer that receives the digital notes may include a stored color lookup table or palette (not shown). The table may include a coded color for each of the keys or tones represented by the keys of a particular instrument. The color palette can be created by a musician/artist. The color code can, for example, be based on the Munsell color code, which gives a proper ratio of primary colors (read, blue and green) for the generation of each color representing a key or note.

FIG. 2 illustrates one contemplated use of the instrument to synchronize the color display with existing music and musicals. A record player, compact disc player, other musical instrument and/or other instrument, may provide a musical note source 110. Notes from a source can either be digital or digitized and applied to the computer which may be programmed and controlled by the musician/artist to generate a visual representation of the music that may be synchronized with music emanating from speakers 49. The instrument also allows artist/musician to play with light as a musician does with sound to create artistic displays. A generated representation, based on the notes received from the instrument and other input sources, can be recorded for later playback. A musician/artist can play music on the piano or other instrument and generate the digital representation of the notes and also use a computer keyboard to generate inputs, all of which can be applied to the computer to provide a visual color display.

It is apparent that a computer can be programmed to control the music display instrument, such as for example, controlling the amplitude or brightness of the colors. It is also possible to have features such as vibrato, wherein the color waivers about a central color. If two or more color keys are depressed simultaneously, the colors could be mixed visually by alternating rapidly between the colors such the viewers eye combines the colors. Alternatively, the colors could be alternately displayed in adjacent small areas such the viewers eye combines the images of intermixed color dots. Incorporation of a computer with the music display instrument enables the creation of many specialized effects. For example, the musical characteristic or attributes of a note, such as pitch, timbre, volume, attack and decay may be taken into consideration when generating representations of the note. Correspondingly, the musician/artist can specify and program the computer to convert audible notes into visual displays.

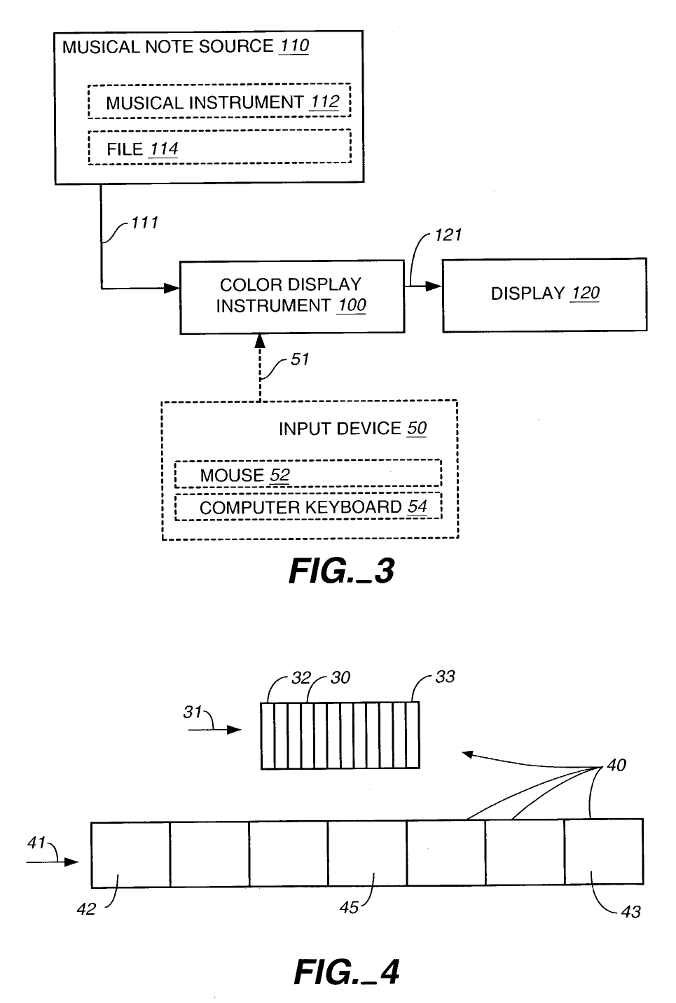

FIG. 3 illustrates a system including a color display instrument, generally designated 100. The color display instrument 100 is coupled with a musical note source 110 using the musical note interface 111, and is coupled with a display 120 using the display interface 121, and is optionally coupled with the input device 50 using an input interface 51. The color display instrument 100 translates a musical note received from the musical notes source into graphical images that may be sent to the display 120. Information from the input device 50 may also be used in generating a graphical representation.

The musical note source 110 may be a musical instrument 112 that is a source of the musical notes received by the color display instrument 100 through the interface 111. Similarly, a file 114 may represent the musical notes source 110. The interface 111 is used to communicate musical notes from the musical note source to the color display instrument. A variety of interfaces may be used, such as the MIDI interface and/or analog interface.

The display 120 is coupled with the color display instrument 100 using a display interface 121. A variety of different display types and display interfaces may be utilized. According to one embodiment, the display 120 is a color television set and/or a color computer monitor.

An input device 50 may be used to control and/or interact with the color display instrument 100. A variety of different input devices and input interfaces may be utilized. Several optional input devices may include a mouse 52 and a computer keyboard 54.

According to one embodiment, an input device 50 may be used to adjust, refine, and/or re-adjust the functionality and attributes of the color display instrument 100. The input device 50 may be used to define patterns, colors, shapes, intensities, positions, one or more musical note sources, a variety of other attributes, and/or a variety of combinations. A visualization of a resulting display 120 corresponding with one or more musical note source 110 may feed back into the color display instrument 100 by a user and/or automatically to control and/or interact with the color display instrument. Further, one or more dialog boxes may be used to facilitate the control and/or interaction with the color display instrument. According to one embodiment, the color display instrument 100 includes two musical notes sources 110, including a singer's voice and a piano keyboard. An input device 50 may be used for enhancing a first graphical display generated based on the note source representing the singer's voice, and may also be used to diminish a second graphical display generated based on the note source representing the piano keyboard. Further, the two graphical displays may be displayed simultaneously and/or combined into a third graphical display.

As shown in FIG. 4 a note 30 is defined within a note group 40. The note group 40 includes a range of notes 31 including a first note 32 and the last note 33. The note group 40 is typically defined in a range of note groups 41 including a first note group 42 and the last note group 43. A reference note group 45 is defined as one of the note groups within the range of note groups 41. Each note group 40 in the range of note groups 41 may be defined according to the position of the note group 40 relative to the reference note group 45. For example, if the reference note group 45 is the middle note group 40 then the note group 43 may be described as a plus 3 note group because it is the third note group to the right of the reference note group 45. Similarly, the note group 42 may be described as a minus 3 note group because it is the third note group to the left of the reference note group 45.

According to one embodiment each note group 40 represent an octave including a range of notes 31 including 12 notes and having a first note 32 and a last note 33. The range of note groups 41 may represents the octaves corresponding to an 88 key piano keyboard.

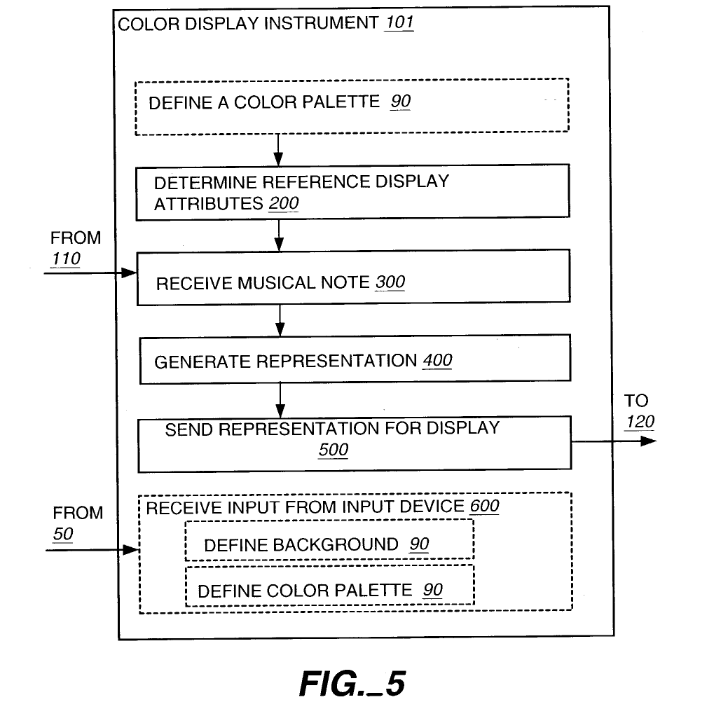

FIG. 5 describes an exemplary method 101 for the operation of a color display instrument 100. Initially a color palette may be defined at 90. Reference display attributes are determined at 200. A musical note is a received at 300 from the musical notes source 110. The received musical note is then used to generate a representation at 400. The generated representation is then sent for display at 500 to a display device 120. Optionally, the color display instrument 100 may receive input from an input device 50 at 600. For example, the received input from an input device may be used to define a variety of information, such as for example, background information at 610. The received input may also be used to define the color palette at 90. Many other uses for the input received from an input device at 600 will also be apparent including interaction with the musical instrument.

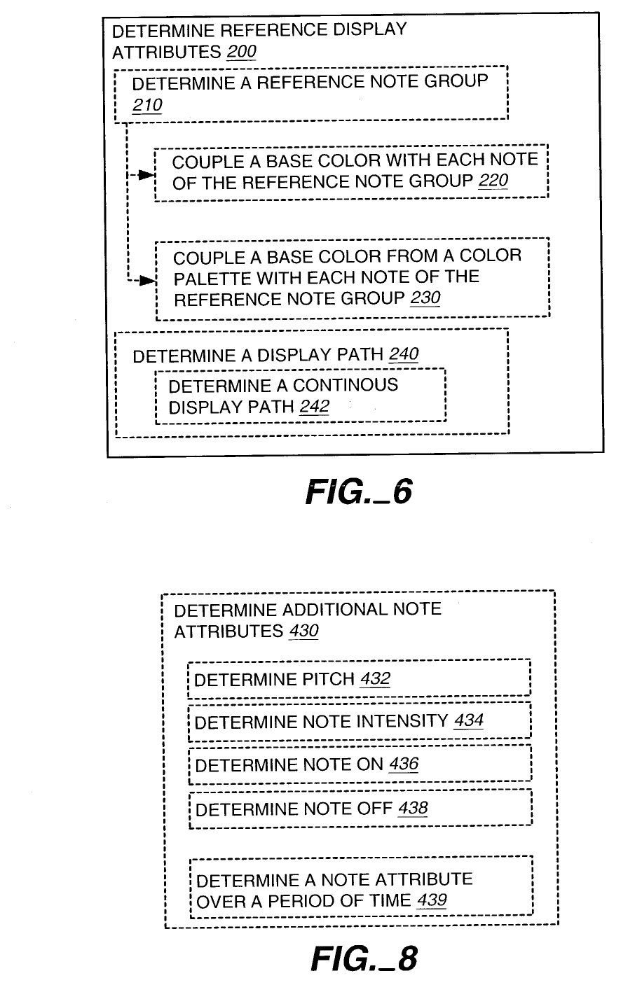

FIG. 6 describes an exemplary method 200 for determining reference display attributes. Determining a reference note group may be performed at 210 and a base color may be coupled with each note of the reference note group at 220. If the color palette had been defined at 90 then a color from the color palette may be coupled with each note of the reference note group at 230. Additionally the display path may be determined at 240 for displaying a note along the display path. In a preferred embodiment the display path is represented as a continuous line that may be determined at 242. Alternatively, the display path may represent path segments that may correspond with individual note groups.

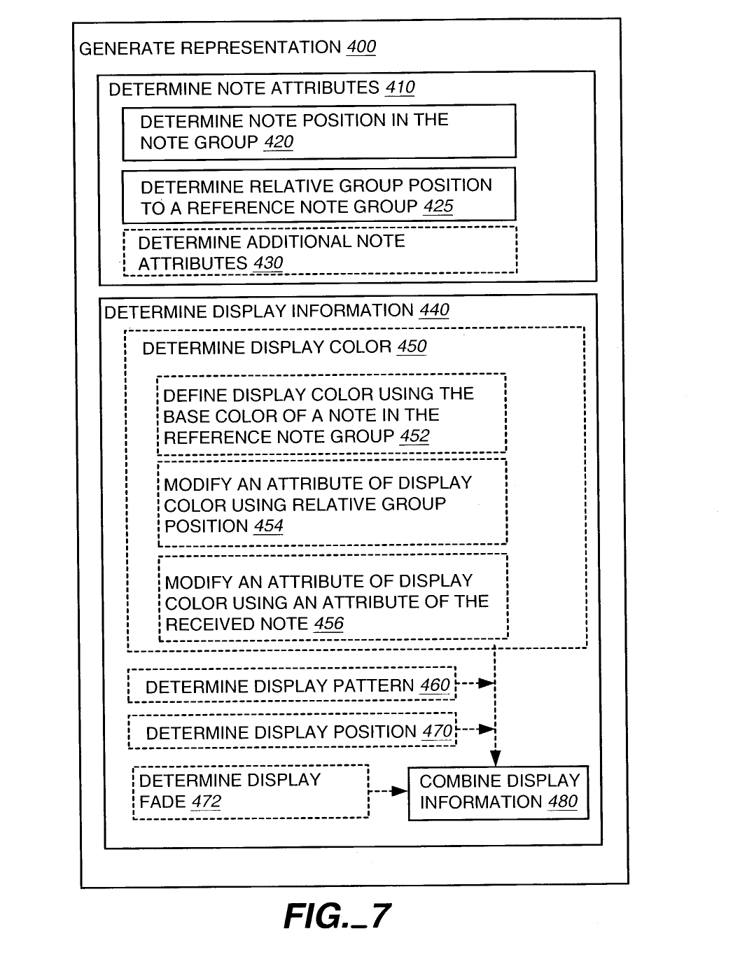

FIG. 7 describes an exemplary method 400 for generating a representation. As illustrated, generating a representation 400 includes determining note attributes 410 and determining display information 440. Determining the note attributes at 410 typically includes determining the note position within the note group at 420 and determining a relative group position to the reference note group 45 at 425. Additional note attributes may be determined at 430.

Determining the display information 440 may include determining a display color at 450, a display pattern at 460, a display position at 470, and other display information such as a display fade at 472. Determining a display color at 450 may include defining a display color using a base color of a note in the reference group at 452. For example, if the received note is the first note of an octave then the display color may be based on the color associated with the first note of the reference group.

Attributes of the display color may also be modified using the relative group position at 454. Attributes of the display color may also be modified using attributes of the received note at 456. For example, the generated representation for a received note may be based on the display color and attributes of the received note. Display information may then be combined at 480, and subsequently sent to the display device 120 and/or stored. Attributes of the display color may include hues, brightness, contrast and fading attributes. A variety of other color attributes may also be used. Attributes of the received note may include pitch, timbre, volume, attack and decay attributes. A variety of other note attributes may also be used.

Additional note attributes may be determined at 430 as illustrated in FIG. 8. Attributes such as the note pitch, note intensity, note on, note off may be determined at 432, 434, 436, and 438 respectively. Additionally, note attributes may be determined over a period of time at 439. For example, the length of time a key on a piano keyboard is depressed may be determined and subsequently used to generate a representation at 400.

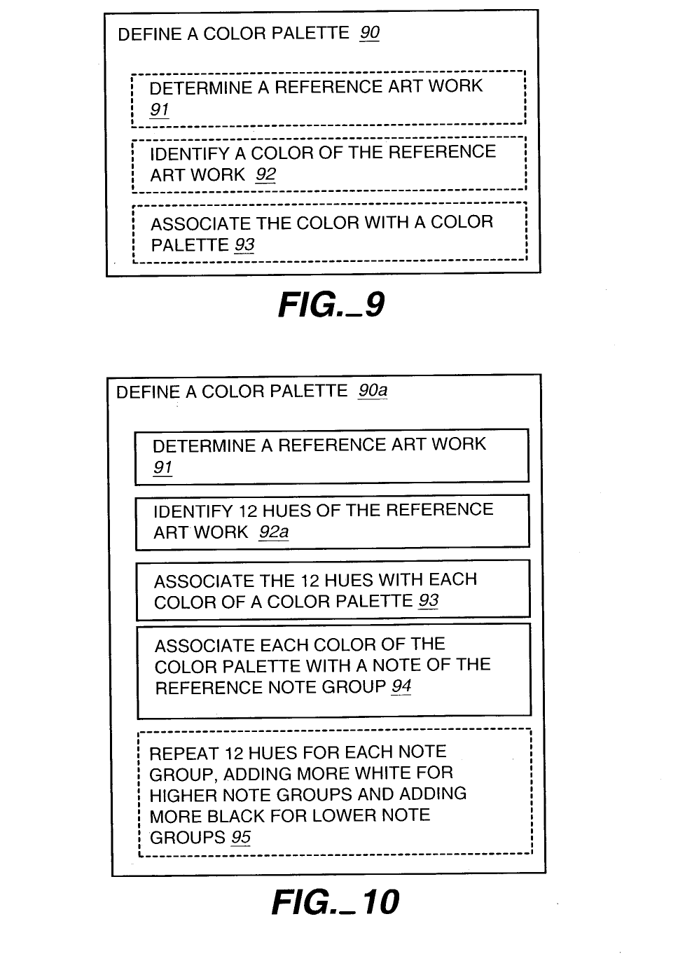

FIG. 9 describes a method 90 of defining a color palette. A reference artwork may be determined at 91. At least one color can be identified from the reference artwork at 92, and the color may be associated with a color of a color palette. Further, FIG. 10 illustrates an exemplary method of defining a color palette at 90a based on the determined artwork at 91. Twelve hues of the reference art work are identified at 92a, and the twelve hues are associated with each color of a color palette at 93. Then, each color in the color palette can be associated with a note of the reference note group at 94. Optionally, the association at 94 may be performed for each note group in the range of note groups. As described above the relative position of each note group 40 to a reference note group 45 may be used to modify a color attribute and define a display color. Accordingly, more white may be added to a color for higher note groups and more black may be added for lower note groups. Alternatively, a color may be associated with each note in the range of note groups 41.

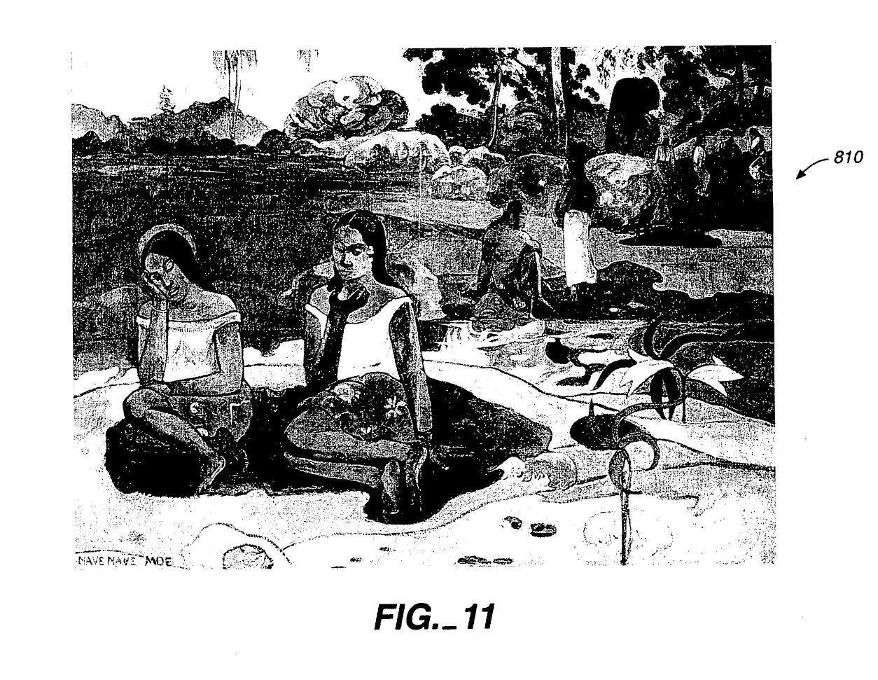

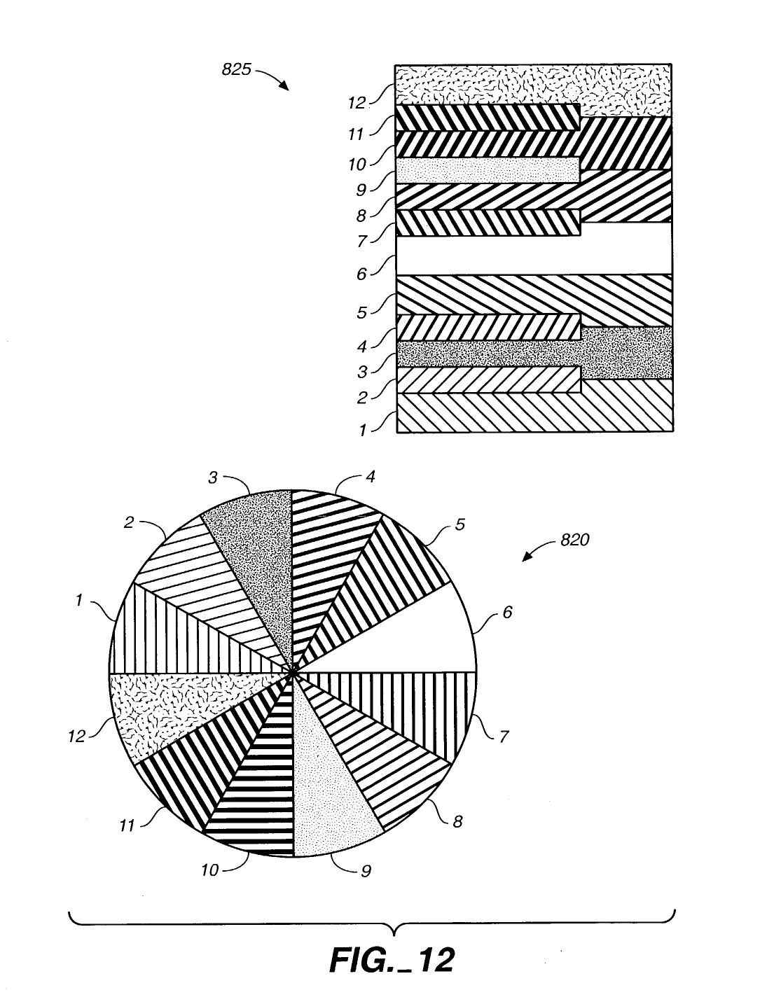

FIG. 11 illustrates an example artwork 810 that may be used to defined at color palette at 90a. Using the artwork 810, twelve hues may be identified at 92a. The twelve hues may be associated with a color palette at 93. The color palette may also be represented as color wheel 820, illustrated in FIG. 12. The color wheel may include colors 1 through 12. Each color of the color wheel may be associated with a note of the reference note group at 94. For example, the range of notes corresponding to an octave 825 of a piano keyboard may be associated with the colors 1 through 12.

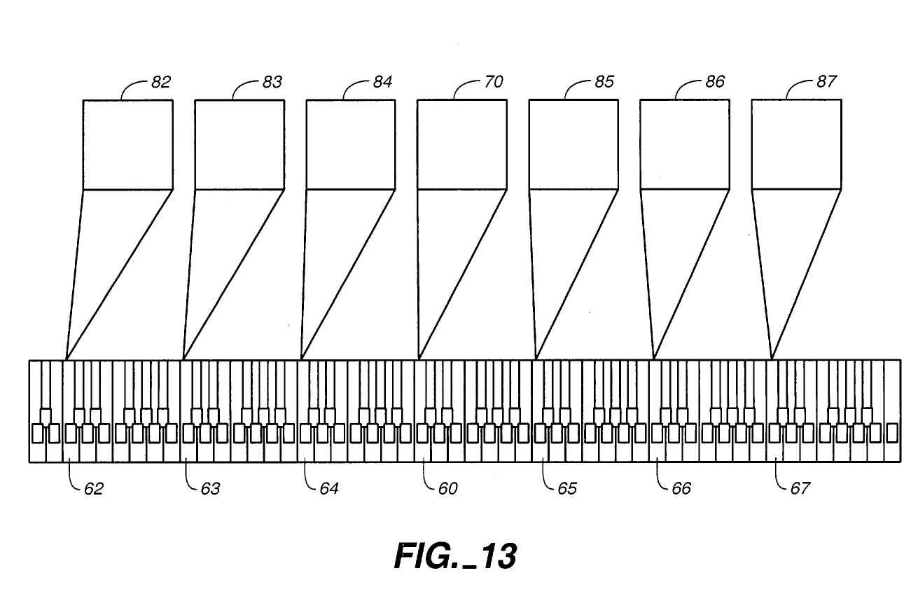

FIG. 13 illustrates associating a display color for a given note within each octave. The middle octave may be a reference octave with each note in the reference octave associated with a reference color. And a display color may be defined for each note in each octave. For example, the reference octave may include a note 60 associated with a reference color 1, described in FIG. 12. The display color for the note 60 may be the same as a reference color 1, because in this case the note 60 is within in the reference note group. A corresponding note 62 in the first octave may be described as a minus 3 octave as described above because it is the third octave to the left of the reference octave. Consequently, the relationship between the first octave and the reference octave may be taken into consideration when defining the display color 82 corresponding to the note 62. In one embodiment, octaves to the left of the reference octave may be assigned more black, such that the display color 82 corresponding to the note 62 may have three shades of black added to the display color.

The display color 83 corresponding with the note 63 of a minus two octave may have two shades of black of the reference color associated with a similar note in the reference octave. Similarly, the display color 84 corresponding with note 64 of a minus one octave may have one shade of black of the reference color associated with a similar note in the reference octave.

The display color 85 corresponding with the note 65 of a plus one octave may have one shade of white of the reference color associated with a similar note in the reference octave. The display color 86 corresponding with the note 66 of a plus two octave may have two shades of white of the reference color associated with a similar note in the reference octave. The display color 87 corresponding with the note 67 of a plus 3 octave may have three shades of white of the reference color associated with a similar note in the reference octave.

It should also be apparent that a variety of color attributes may be used in organizing the display colors for each note within the respective note groups and/or octaves. Additionally, the inputs from an input device 50 may also be taken into consideration when defining the display colors and the reference colors.

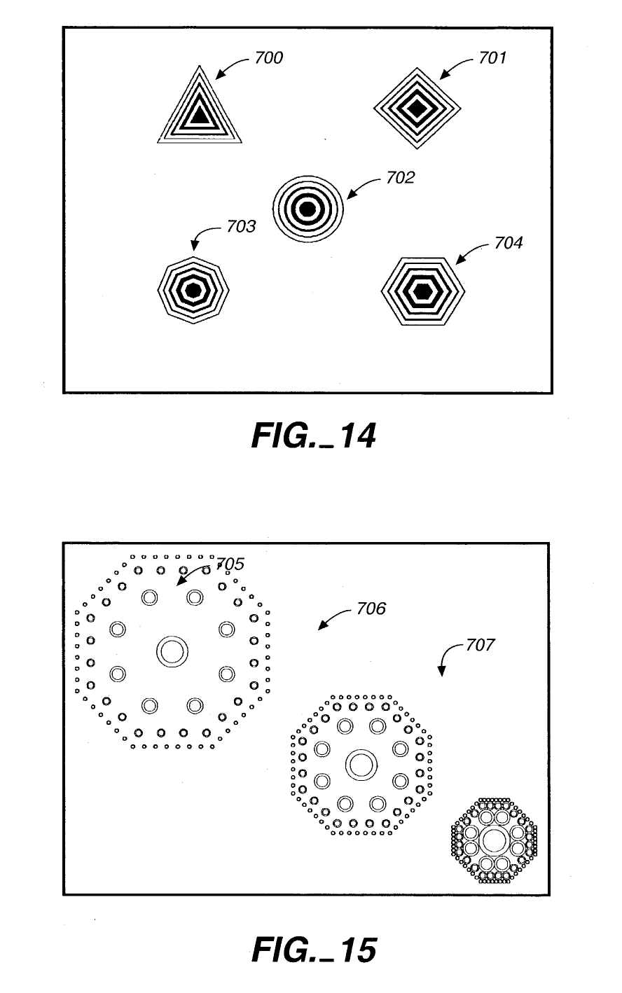

FIG. 14 illustrates several patterns that may be used to define a display pattern including a triangle 700, a square 701, a circle 702, a hexagon 703, and a Pentagon 704. As shown, each of the display patterns include five separate outlines of the same symbol. It should also be apparent that a variety of other symbols and combinations of symbols may be used to define a display pattern for received musical note.

As further illustrated in FIG. 15, a display pattern may be more complex. The display pattern 705 includes a variety of shapes which may be interrelated. The display pattern 705 may be expanded into the display pattern 706, and further expanded into the display pattern 707. For example, this expansion may be the result of depressing a key on a piano keyboard for a given duration of time. If the key is depressed for a first duration of time, such as, for example one second, the display pattern may evolve from the 705 pattern to a 706 pattern. If the key remains depressed for an additional one second then the display pattern may evolve from the 706 pattern to a 707 pattern. A variety of other combinations may be used to change the size and appearance of the note representation.

For example, the note intensity corresponding to a received note may be used to select a pattern. A note with a minimal intensity may result in the display pattern 705. A note with moderate intensity may result in the display pattern 706. Whereas, a note high intensity may result in the display pattern 707. Further, the note position may reside in the same location for a given note with the size of the display pattern varying based on the note intensity and/or other note attributes.

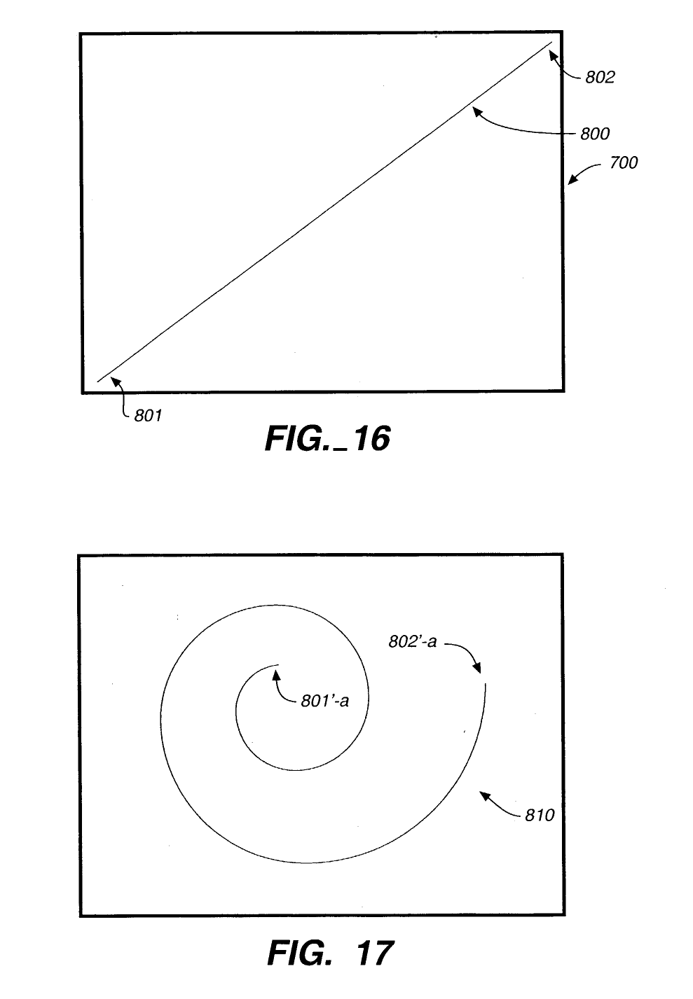

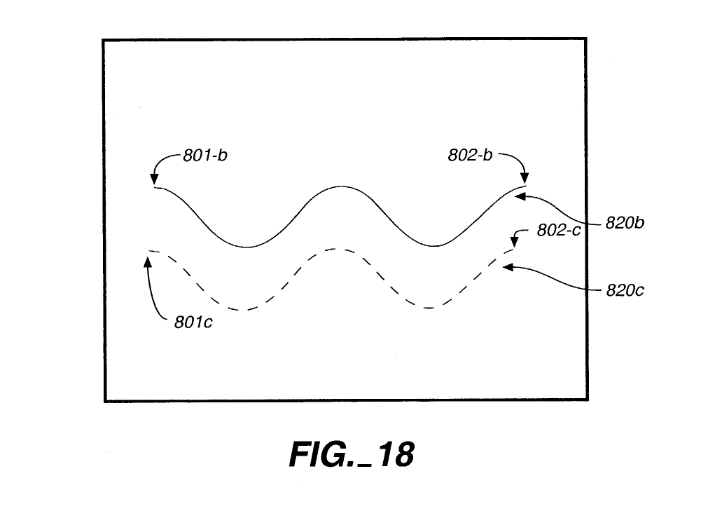

FIG. 16 illustrates a graphical path 800 as a straight path including a graphical path first position 801 and a graphical path last position 802. FIG. 17 illustrates a graphical path 800b as a spiral path. FIG. 18 depicts the display path 820 as a wavy path which may change orientation within the display over a period of time. As shown the wavy path 820b may move to a second position 820c and may maintain a similar path pattern. Alternatively, the path may evolve into a different path such as for example a straight path may change into a wavy path.

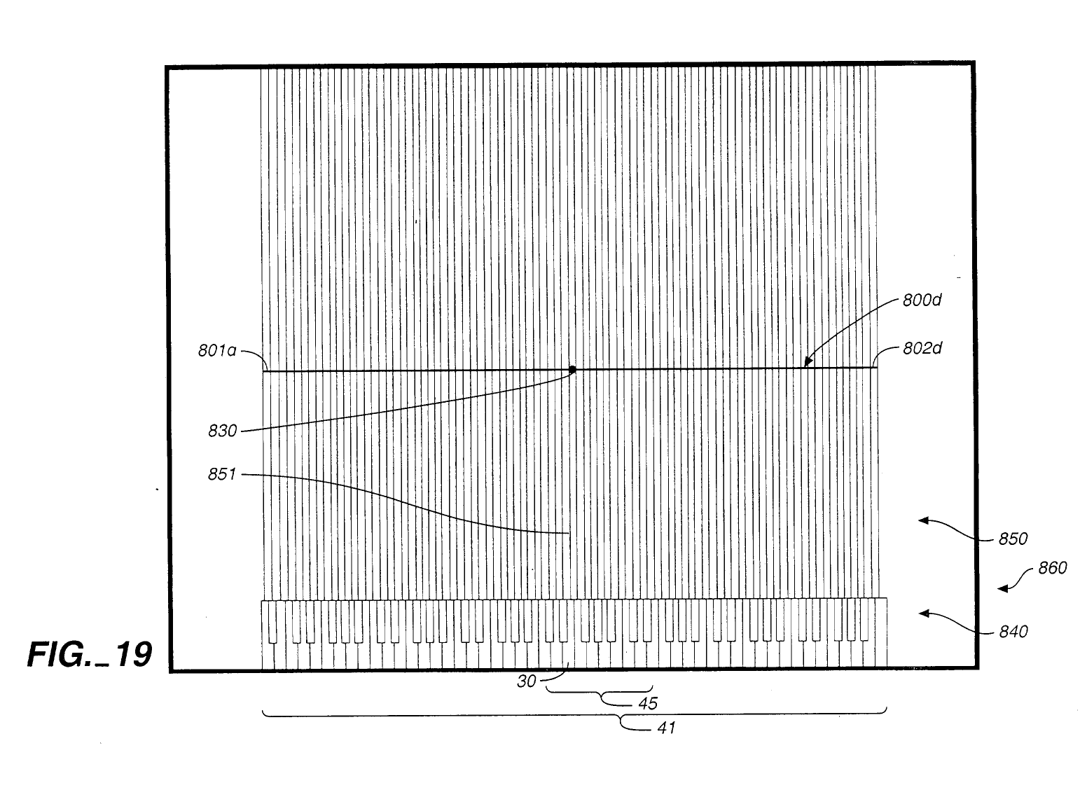

FIG. 19 illustrates a graphical path 800d and a superimposed a piano keyboard image including a range of note groups 41 corresponding to range of octaves. As shown, the graphical path 800d has a correlation with the received notes from a piano keyboard. The reference note group 45 may be disposed as a middle octave including the note 30. Receiving the note 30 from another source 110 may result in highlighting a note line 851 from a set of note lines 850 corresponding with the superimposed keyboard image 840. Receiving the note 30 may also result in displaying a pattern at a position 830 along the graphical path 800d. Similarly, other received notes typically correspond with a position on the graphical path 800d. According to one embodiment, the graphical path 800 represents an initial display position for note representations, where the position may be modified based on the note attributes and/or color attributes.

It should also be apparent that other note attributes may be used in organizing the display position for each note. For example, inputs from the input device 50 may be taken into consideration when defining the display position. As depicted in FIG. 19 a received note may be displayed in three separate positions simultaneously. A first position along the graphical path 800 about the point 830. A second position about the note line 851. And a third position represented by the key corresponding to the note 30 on the superimposed keyboard image 840.

FIG. 19 further illustrates a display representation corresponding to the musical note source 860. As shown musical note source 860 includes a graphical path 800d, a set of note lines 850, and the superimposed keyboard image 840. It should also be apparent that other display information corresponding with a wide variety of musical instruments may be used to represent the display information for a musical note source.

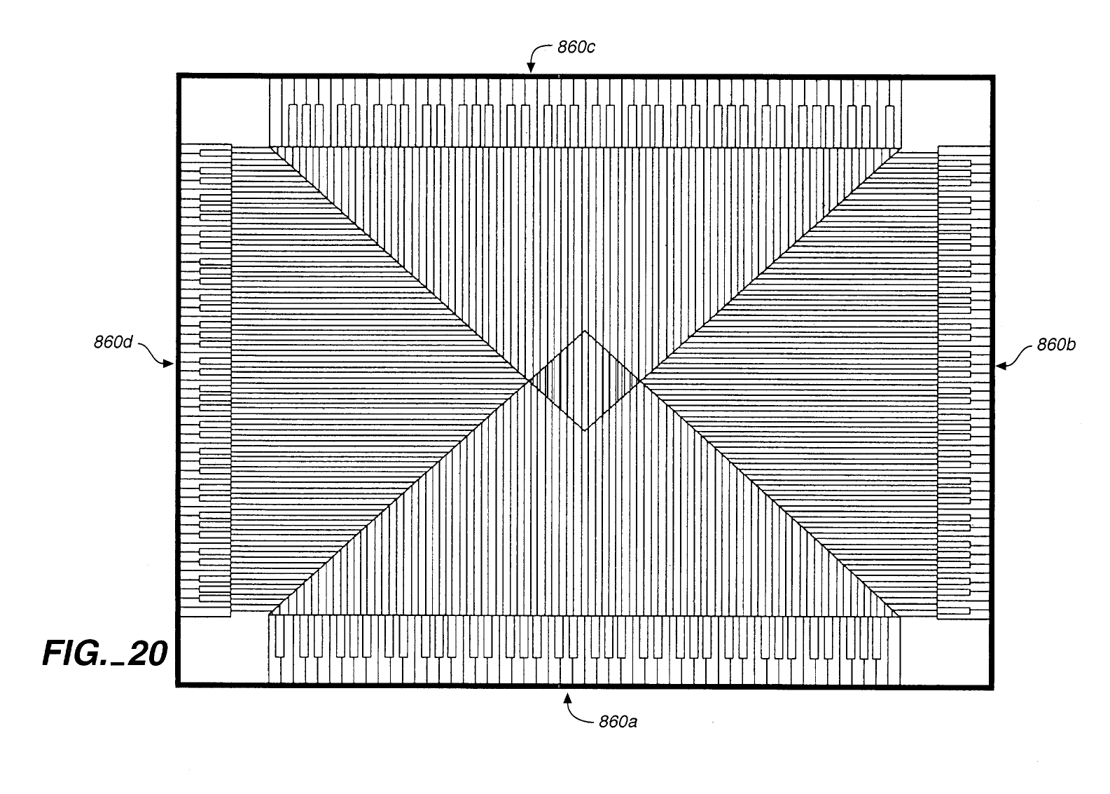

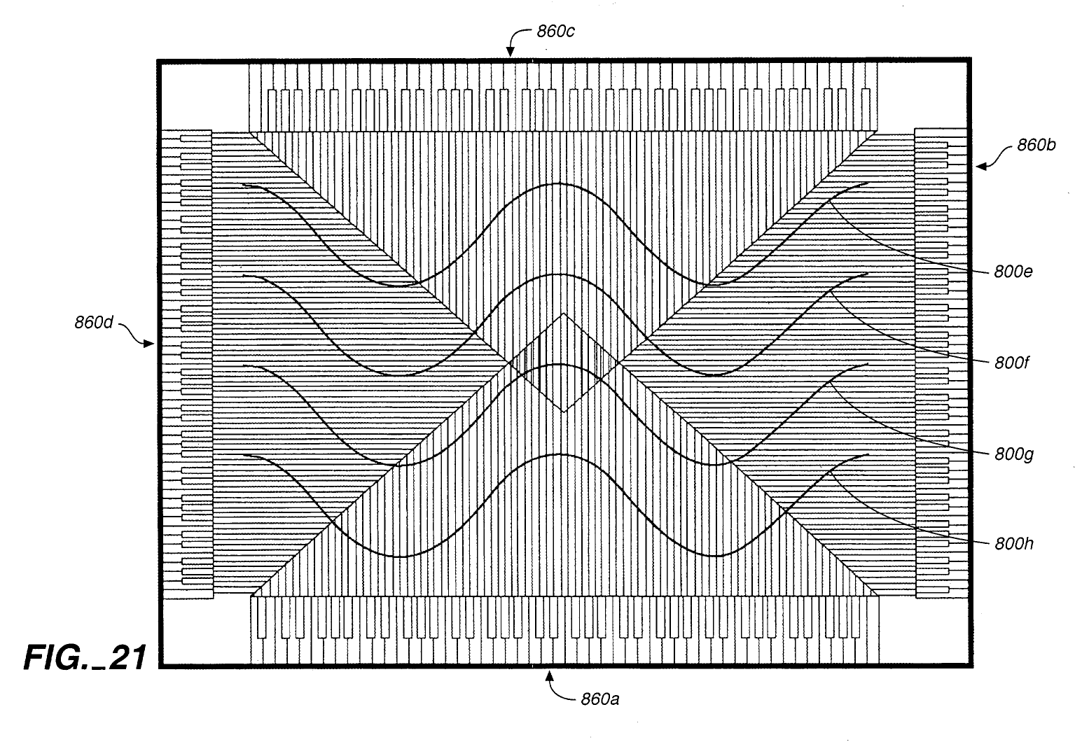

FIG. 20 illustrates the musical note source 860a, 860b, 860c, and 860d corresponding to four piano keyboards. FIG. 21 further adds graphical paths 800e, 800f, 800g, and 800h corresponding to the respective musical note sources 860a, 860b, 860c, and 860d. Each musical note source 860x may represent separate display information corresponding to an individual musical note source such as from four separate instrument.

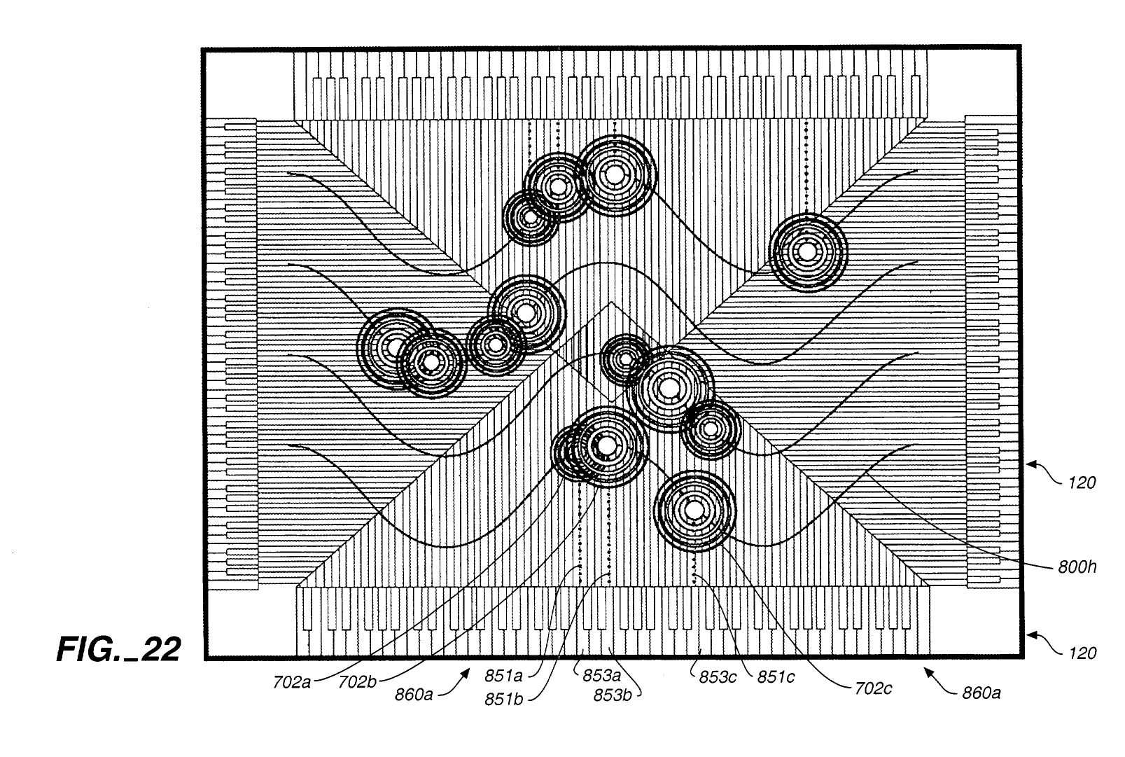

FIG. 22 illustrates a display representation including a combination of display color, display pattern, and display position on the display device 120. The display color may be generated as described above. As illustrated, three notes have been received by the color display instrument 100, which has generated representation for the three notes. The notes are associated with the piano keyboard image keys 853a, 853b, and 853c. The generate representation at 400 as illustrated includes generating several corresponding representation for each received musical note. A dashed lines 851a, 851b, and 851c graphical representation is generated at 400 for display above the corresponding piano keyboard images. The display pattern 702a, 702b, and 702c graphical representation is generated at 400 for display along the display path 800h. A graphical representation may also have been generated at 400 for displaying color associated with the specific keys 853a, 853b, and 853c of the piano keyboard image. A display pattern may be generated for each received note for placement about the position on the display path 800h. The display pattern may also fade in and out over a duration of time.

As illustrated, the display pattern 702a is of smaller dimension than the display pattern 702b. The disparity in size may be generated in correlation with how the musical notes were received from the input source. The musical note corresponding to the display pattern 702a may have been released and may be fading out based on the representation generated at 400. A variety of other graphical representations of a received note and/or a group of received notes may be supported.

In a preferred embodiment, the present invention may supports receiving musical notes corresponding to a song and generating a graphical representation. The graphical representation may be displayed in conjunction with playing the song or independently of playing the song.

It should also be apparent that a variety of note attributes may be used to determine the display color, pattern, and/or position. For example, the pitch of note may be used to determine the color and position. The note intensity may be used to determine the pattern size. The note being turned “on” may result in a display pattern fading in, and correspondingly the note being turned “off” may result in the display pattern fading out.

It should also be apparent that a variety programming techniques may be used to support and implementation of described innovations using a computer 45 and/or specialized computing system. Several programming techniques may utilize the functionality of sound cards, MIDI interpreters, and/or video display languages such as for example OpenGL (TM), a trademark of Silicon Graphics of Mountain View, Calif. The OpenGL (Open Graphics Library) provides a software interface to graphics hardware. A OpenGL interface consists of a set of several hundred procedures and functions that allow a programmer to specify the objects and operations involved in producing high-quality graphical images including color images and three-dimensional objects.

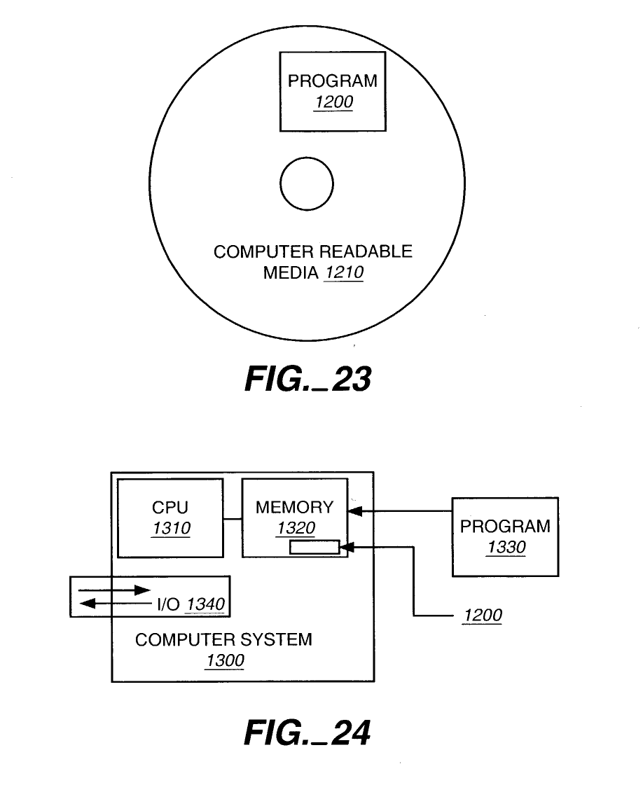

FIG. 23 depicts an embodiment of the method according to the present invention on a computer readable media. A computer program 1200 representing at least one of the methods described herein. The program 1200 is coupled with a computer readable media 1210, such that a computer or computer system could read and execute the computer program 1200.

FIG. 24 depicts a computer system 1300 including a CPU 1310, a memory 1320, and support for input and output 1340. The computer program 1200 may be loaded into a memory 1320 accessible to the computer or the computer system 1300, which is capable of executing the program 1200. Alternatively, the program 1200 may be permanently embedded in the memory 1320. The support for input and output 1340 typically interacts with the program 1200.

Advantageously, the color display instrument can generated graphic representation of received notes. Consequently, a beautiful melody can be seen as well as heard. A further advantage of the present invention includes providing an artistic avenue for vividly presenting music to the delight of musicians and spectators alike.

For convenience in explanation and accurate definition in the appended claims, the terms “first”, “last”, “up” or “upper”, “down” or “lower”, “inside” and “outside” are used to describe features of the present invention with reference to the positions of such features as displayed in the figures.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A color display instrument for graphically displaying on a display device a musical note in a range of notes of a note group in a range of note groups, comprising:
means for determining display attributes of a reference note group selected from the range of note groups;
means for receiving a musical note; and
means for generating a representation of the received musical note using a note position of the received note in the note group and a relative group position of the note group to the reference note group; display means; and means for receiving the representation of the received musical note and applying it to the graphical display to provide a graphical display of the musical note.

2. The color display instrument of claim 1 wherein the said means for generating a representation further includes:
means for determining a display color for displaying the received musical note;
means for determining a display pattern for displaying the received musical note;
means for determining a display position of the received musical notes along a path corresponding to each note in the range of note groups; and
means for combining the display color, the display pattern, and the display position.

3. A display instrument for graphically displaying musical notes, the instrument comprising:
means for receiving a digital representation of a musical note;
a processor configured to generate a representation of the received musical note using a note position of the received note in a note group and a relative group position of the note group to a reference note group; and
means for receiving the representation and providing a graphical display.

4. The display instrument of claim 3 wherein the processor configured to generate a representation further includes:
means for determining a display color for displaying the received musical note;
means for determining a display pattern for displaying the received musical note;
means for determining a display position of the received musical notes along a path corresponding to each note in the range of note groups; and
means for combining the display color, the display pattern, and the display position.

5. A method for graphically displaying on a display device a musical note in a range of notes of a note group in a range of note groups, the method comprising:
determining display attributes of a reference note group selected from the range of note groups;
receiving a musical note;
generating a representation of the received musical note using a note position of the received note in the note group and a relative group position of the note group to the reference note group; and
sending the representation for graphically display.

6. The method of claim 5 wherein the note group is an octave.

7. The method of claim 5 wherein the generating a representation further comprises:
determining a display color for displaying the received musical note;
determining a display pattern for displaying the received musical note;
determining a display position of the received musical notes along a path corresponding to each note in the range of note groups; and
combining the display color, the display pattern, and the display position.

8. The method of claim 5 further including generating the signal using an electronic instrument.

9. The method of claim 8 wherein the electronic instrument is a piano keyboard.

10. The method of claim 5 wherein the determining display attributes further comprises coupling each note in the range of notes of the reference note group with a base color.

11. The method of claim 10 wherein the generating a representation further comprises determining a display color for displaying the received musical note including:
defining the display color as the base color of a note in the reference note group using the note position; and
modifying an attribute of the display color using the relative group position.

12. The method of claim 7 wherein the determining a display color further includes:
defining the display color as the base color of a note in the reference note group using the note position; and
modifying an attribute of the display color using the relative group position.

13. The method of claim 12 wherein the attribute of the display color is selected from a group of color attributes consisting of: a hue attribute, a brightness attribute, a contrast attribute, a fading attribute, and combinations thereof.

14. The method of claim 7 wherein the determining a display pattern is performed before receiving the signal.

15. The method of claim 7 wherein the determining a display position uses a predetermined continuous path.

16. The method of claim 7 wherein the determining a display color further includes:
defining the display color as the base color of a note in the reference note group using the note position; and
modifying an attribute of the display color using a note attribute of the received musical note.

17. The method of claim 16 wherein the note attribute is selected from a group of note attributes consisting of: a pitch note attribute, a treble note attribute, an intensity note attribute, a note on note attribute, a note off note attribute, and combinations thereof.

18. The method of claim 16 further comprising determining a note attribute identifying a change in a note attribute of a musical note over a period of time.

19. The method of claim 17 further comprising determining a note attribute based on the change of a musical note over a period of time and an input from an input device.

20. The method of claim 5 further including defining a color palette, wherein the determining display attributes uses the color palette, defining the color palette comprises:
determining a reference art work;
identifying a color of the reference art work; and
associating the color with the color palette.

21. The method of claim 20 wherein associating the color includes associating twelve colors with the color palette.

22. The method of claim 5 further comprising
determining a base display color for each musical note using the note position of the note in the note group and the relative group position of the note group to the reference note group.

23. A computer-readable medium consisting of a program including at least one instruction for causing a processor to process a musical note in a range of notes of a note group in a range of note groups, by
determining display attributes of a reference note group selected from the range of note groups;
receiving a musical note;
generating a representation of the received musical note using a note position of the received note in the note group and a relative group position of the note group to the reference note group; and
sending the representation for graphically display.

24. The computer-readable medium of claim 23 wherein the generating a representation further comprises:
determining a display color for displaying the received musical note;
determining a display pattern for displaying the received musical note;
determining a display position of the received musical notes along a path corresponding to each note in the range of note groups; and
combining the display color, the display pattern, and the display position.

25. A computer system comprising:
said computer-readable medium of claim 23; and
a CPU coupled to said medium for executing said program therein.
